(19) United States
(12) Patent Application Publication
(10) Pub. No.: US 2010/0250462 A1
(43) Pub. Date: Sep. 30, 2010

(54) AltUse Rating Application

(76) Inventors: Michael Wheeler, Long Beach, CA (US); Benjamin Paul Goldfarb, Sherman Oaks, CA (US)

Correspondence Address: Benjamin Goldfarb, 4816 Ranchito Avenue, Sherman Oaks, CA, 91423, US

(21) Appl. No.: 12/750,435

(22) Filed: Mar. 30, 2010

Related U.S. Application Data
(60) Provisional application No. 61/211,348, filed on Mar. 30, 2009.

(51) Int. Cl. G06Q 99/00

(52) U.S. Cl. 705/347

(57) ABSTRACT

The present invention relates to the field of rating and evaluating user-generated content on an Internet site. More particularly, the invention relates to a method and system of rating how well product alternative uses work based on user feedback.

This Non-Provisional Patent application claims priority from provisional patent application No. 61211348

### TITLE OF THE INVENTION

The AltUse Rating Application is invented by the following persons: Michael Wheeler, 68Lime, #6, Long Beach, Calif. 90802, who is a citizen of the United States; and Benjamine Goldfarb, 4816Ranchito, Sherman Oaks, Calif. 91423, who is a citizen of the United States.

### CROSS REFERENCE TO RELATED APPLICATIONS

Non-applicable

### FEDERALLY SPONSORED RESEARCH OR DEVELOPMENT

Non-applicable

### REFERENCE TO SEQUENCE LISITNG, A TABLE OR COMPUTER PROGRAM, ETC.

Non-applicable

### BACKGROUND OF THE INVENTION

User generated content currently provides Internet users with opportunities to create and publish content online or to consume content by reviewing it online. In 2008, there were 85million user-generated content creators online and 115 million user-generated content consumers.¹ ¹“A Spotlight on UGC Participants,” Paul Verna, Senior Analyst, www.emarketer.com, Feb. 19, 2009

Many user-generated content sites, including ehow.com, epinions.com, and youtube.com, have successful business models by creating platforms for users to publish and to rate the quality of user-generated content. The ranking systems and voting criteria are specific to each site's business model. For example, epinions.com offers a different set of voting criteria based on the type of products that users evaluate, such as cars, computer equipment, etc. It also provides site registrants with the opportunity to determine the credibility of a review based upon a previous designation of the reviewer as “trustworthy.” Youtube.com allows users to vote on the appeal and quality of an uploaded video.

Some web sites offer very basic user generated content that addresses product alternative uses for every day products, web sites such as thrifty.com, ehow.com, and yahooanswers.com. However the product alternate use content is ancillary to these sites business model, and they do not provide alternative uses across multiple categories. Nor do they offer a system and methodology uniquely designed to determine the best and worst alternative uses for every day products, helping to save consumers and businesses money.

### BRIEF SUMMARY OF THE INVENTION

Embodiments of the invention comprise methods and systems that provide users with the opportunity to vote on and to rank product alternative uses based on their perceptions of whether the alternative use worked, its utility and value. Such voting on and ranking of specific criteria yields an AltUse Rating score, which tabulates and statistically compares the utility of one alternative use with all other alternative uses in the database. The goal of the invention is to identify those products that have alternative uses that help consumers save money, minimize waste and offer extended utility.

### BRIEF DESCRIPTION OF THE DRAWINGS

FIG. 1 illustrates a flow diagram of the submission of a product alternative use by a site registrant.

FIG. 2 illustrates a flow diagram of a user rating a product alternative use by selecting an option associated with each voting variable.

FIG. 3 Illustrates a flow diagram of the creation of an AltUse Rating for a specific product alternative use based on users' voting behavior for and page views of that alternative use.

### DETAILED DESCRIPTION OF THE INVENTION

Reference will now be made to embodiments of the invention as illustrated in the text and accompanying drawings. The same reference numbers are used throughout the drawings and the following description to refer to the same or like parts.

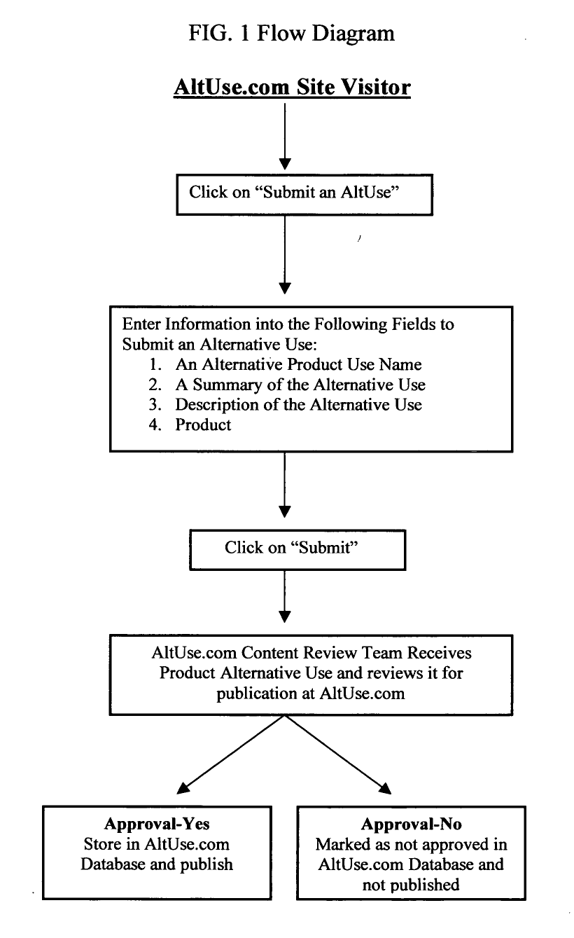

FIG. 1 is a diagram that illustrates how a user submits an alternative use. The user visits www.altuse.com via a desktop or laptop computer, or any such device that interfaces with www.altuse.com. The user then clicks on the “Submit an AltUse” link on the home page, or on numerous other pages within the site with the same link, to upload content.

The user interfaces with a web page that provides fields to capture the following:
1) An alternative product use name,
2) A summary of the alternative use,
3) Description of the alternative use, and
4) The underlying product that will be used to create the alternative use.

After inputting the information in each of the four fields, a user then clicks on the “Submit” link and uploads the product alternative use to www.altuse.com for review, approval, and subsequent publication within the product alternative use database where other users may view the product alternative use and vote on it.

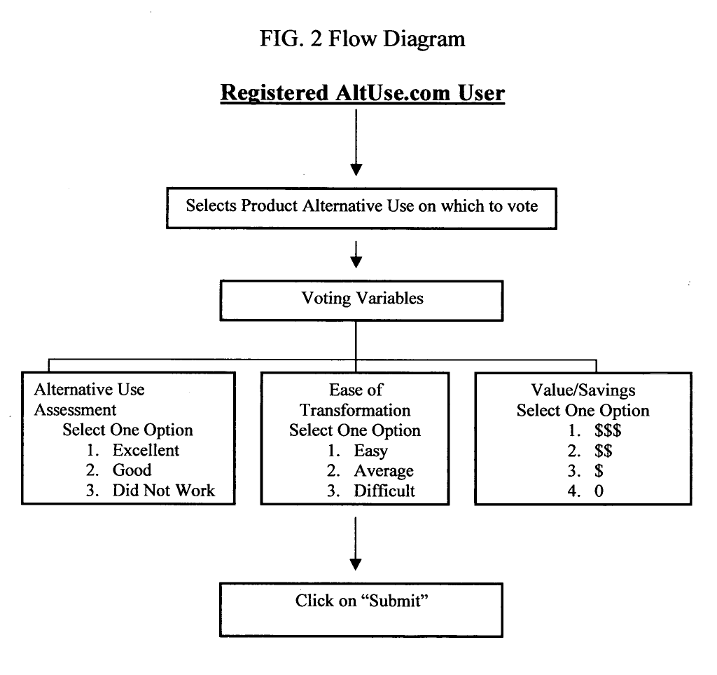

FIG. 2 illustrates the process of a user voting on a product alternative use. A user selects the product alternative use on which she chooses to vote by clicking on the link “Read More.” A user is then presented with the following options on which to vote:
1) Alternative Use Assessment—How well a product's alternate use works, with the options “Excellent,” “Good,” and “Did not work” from which users may select one option.
2) Ease of Transformation—The ease of transformation so that the product may be used in an alternative use manner, with the options “Easy,” “Average,” and “Difficult,” from which users may select one option.
3) Value/Savings—The amount of money saved or alternative value created by using the product in an alternative manner, with the options “$$$,” “$$,” “$,” and “0,” from which users may select one option.

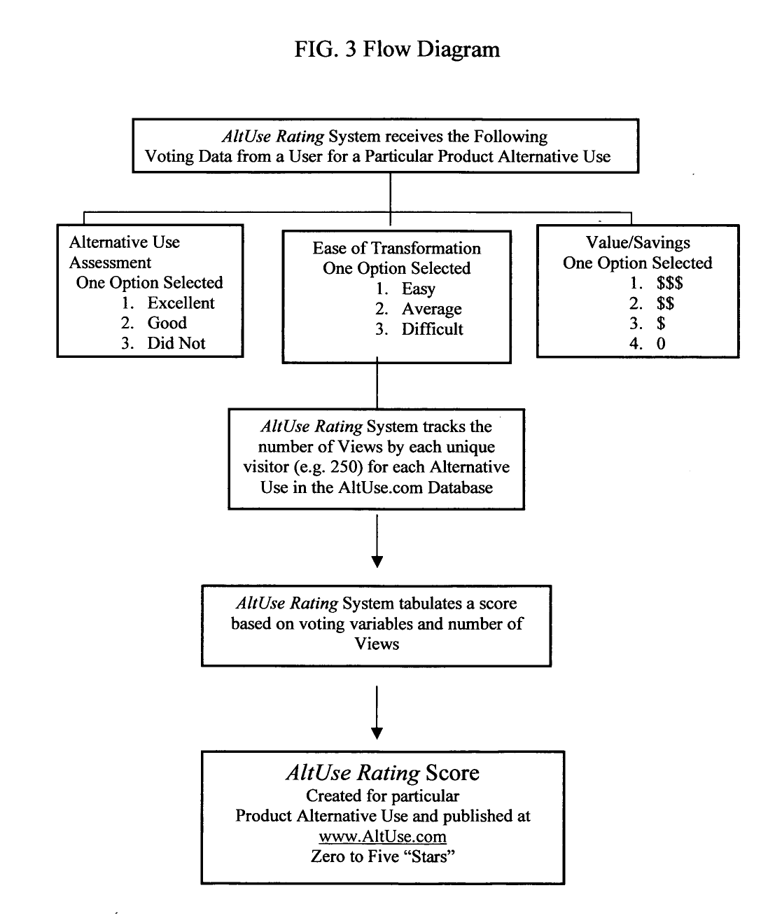

FIG 3 illustrates how an AltUse Rating is calculated for a product alternative use. The rating of these product uses is based in part on users' responses. Those responses include an “organic” response, which is the number of times a product use is viewed per day per unique visitor or—Number of Clicks. The other source of rating information is users' ratings of specific product uses aspects including user's product use ratings. There are three of these types of ratings as referenced in paragraph [0010]. How well a product's alternative use works, the Alternative Use Assessment; the ease of a product's transformation so that it can be used in a alternative manner, the Ease of Transformation; and finally, the amount of money saved by using the product in an alternative manner, the Alternative Use Value/Savings.

Users' ratings of these criteria are used to produce a final AltUse Rating for each product alternative use, which is based on a statistical method that tabulates the results in real time as users vote and visit product alternative use web pages at www.altuse.com. In addition, the final AltUse Rating calculation is statistically compared to other products in both the same product category and also the entire AltUse database for tabulation. Whole and half “Stars” will designate the AltUse Rating for a product alternative use, with one Star as the lowest rating, and five Stars as the highest rating. Note: Currently the AltUse database contains 21product categories.

1. An online method for rating and evaluating whether a product alternative use works, offers utility and its transformative value based on system tabulations and user responses to multiple variables' scoring the product alternative use detail as presented via website www.AltUse.com.

2. The method of claim 1 wherein a statistical formula is applied to each variable, and the, sum of each statistical variable is tabulated, which creates subjective yet telling value for each product's Alternative Use, the AltUse Rating.
